(19) United States
(12) Patent Application Publication
(10) Pub. No.: US 2017/0345003 A1
(43) Pub. Date: Nov. 30, 2017

(54) ENHANCING ELECTRONIC INFORMATION SECURITY BY CONDUCTING RISK PROFILE ANALYSIS TO CONFIRM USER IDENTITY

(71) Applicant: PAYPAL, INC., San Jose, CA (US)

(72) Inventors: Justin Spears, San Jose, CA (US); Michael Charles Todasco, San Jose, CA (US)

(21) Appl. No.: 15/163,763

(22) Filed: May 25, 2016

(51) Int. Cl. G06Q 20/40; H04L 12/58; H04L 29/06; H04L 29/08; G06F 21/62

(52) U.S. Cl. CPC G06Q 20/4016; H04L 67/306; H04L 67/12; G06F 21/6254; H04L 63/102; H04L 51/22; H04L 67/02

(57) ABSTRACT

An email address is provided by a user when the user registers an account with a service provider. A unique ID is generated for the user. An email containing the unique ID is sent to the email address. The unique ID is embedded as a part of a URL link or in a loadable image. A user response to the email is detected. The user response includes a request to access the URL link or to load the image. Subsequently, the unique ID is retrieved from the request. The email address is confirmed as a valid email address if the retrieved unique ID is identical to the generated unique ID. A Turing test is conducted to determine whether the user is a computer bot. Access to the user account is granted only if the email address is confirmed as valid and the user is determined to not be a bot.

### BACKGROUND

Online transactions are becoming more and more prevalent, with an ever-increasing number of online entities that may or may not have a physical real world counterpart. Furthermore, the services offered by these online entities have been improving as well. The popularity of online transactions is partially attributable to the ease and convenience of making a transaction online instead of at a physical location. Unfortunately, the popularity of online transactions has also led to an increase in online fraud activities. For example, imposters may pose as another person when registering for an account with a service provider. Computerized algorithms known as “bots” have also been used in various contexts to pose as human users. Currently, service providers have not been able to devise a simple and yet reliable way to verify the user—that is, making sure the user is indeed who he/she says he/she is, rather than a “bot” or an imposter.

Therefore, although existing systems and methods of performing verifying user identity is generally adequate for their intended purposes, they have not been entirely satisfactory in every aspect. What is needed is an enhanced scheme for service providers to reliably verify the user identity without requiring significant user interaction.

### BRIEF DESCRIPTION OF THE FIGURES

FIG. 1 is block diagram of a networked architecture suitable for conducting electronic online transactions according to embodiments of the present disclosure.

FIGS. 2-11 illustrate example user interfaces of an electronic device displaying a web page or an email according to embodiments of the present disclosure.

FIG. 12 is a flowchart illustrating a method of using a user response time to conduct a risk profile analysis according to an embodiment of the present disclosure.

FIG. 13 is a flowchart illustrating a method of enhancing electronic information security by conducting risk profile analysis to confirm user identity according to embodiments of the present disclosure.

FIG. 14 is a diagram illustrating an example cloud computing architecture according to embodiments of the present disclosure.

FIG. 15 is a block diagram of a computer system suitable for implementing one or more components in FIG. 1 according to embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

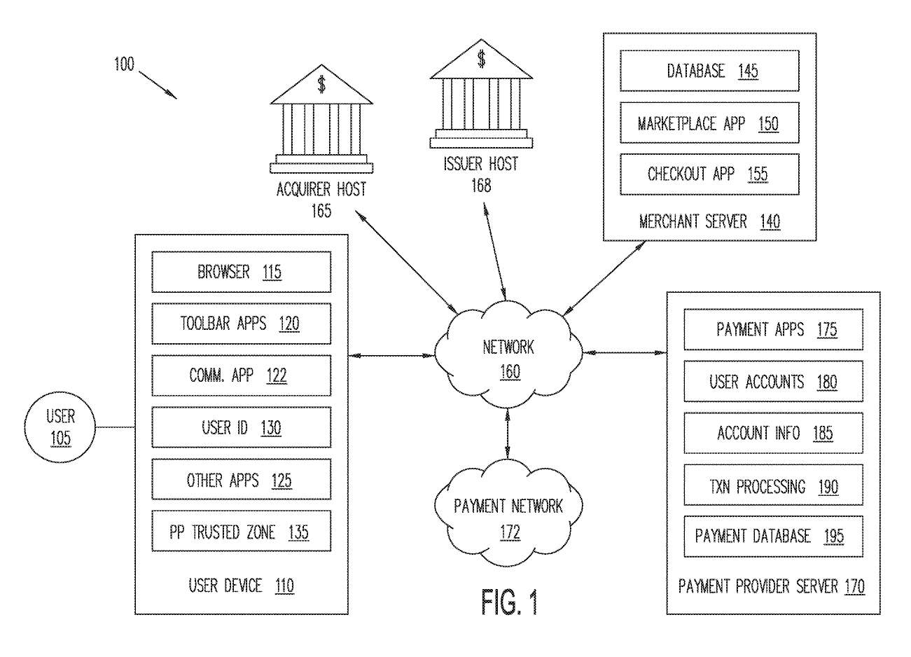

The present disclosure involves establishing and analyzing risk profiles for users to verify the identity of users who have registered an account with a service provider. Based on the risk profile analysis, account access may be denied to “users” who are suspected to be computer “bots” or other human imposters, while legitimate human users may be granted account access. In addition, the present disclosure offers easy and convenient mechanisms for users to knowingly or unknowingly confirm their email addresses as being valid. Therefore, whereas electronic information security fraud and low user response rates (for communication sent by service providers) have plagued conventional systems and methods, the present disclosure offers technical solutions that are necessarily rooted in computer technology to solve these problems that also arise in the electronic information security context, as discussed in more detail with reference to FIGS. 1-12.

FIG. 1 is block diagram of a networked system or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

User device 110 may install and execute a payment application received from the payment service provider to facilitate payment processes. The payment application may allow a user to send payment transaction requests to the payment service provider. In particular, the payment application may authenticate user 105 before making payments. In an embodiment, the payment application may implement automatic authentication of the user 105 when the user 105 is at certain payment locations. The payment application in conjunction with the payment service provider may also provide proxies for user's credentials and funding instruments (e.g., payment and identity proxies for transaction) within secure zone 135 to be used with/without further authentication with payment service provider depending on the transaction or payment situation. The payment application may also receive relevant payment and identity proxies from proximity based ancillary systems such as a Bluetooth beacon installed in the merchant's premises in association with the payment service provider for the purpose of processing transactions or providing value added services to the user.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Account information may also include user purchase history and user ratings. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In one embodiment, payment provider server 170 may include a token vault storing various information on token formats, conventions, data, and the like. For example, a token may be generated for a user's payment account to allow payment transactions using the token. A user's identity information, preferences, or other information may be stored and associated with the user's account and mapped to tokens. Merchant accounts at the payment provider server 170 also may store merchant's information, such as type of merchant, product or service offered, method of payments, and the like to ensure diversified use of tokens that may vary by merchant type/service etc.

Payment network 172 may be operated by payment card service providers or card associations, such as DISCOVER®, VISA®, MASTERCARD®, AMERICAN EXPRESS®, RUPAY®, CHINA UNION PAY®, etc. The payment card service providers may provide services, standards, rules, and/or policies for issuing various payment cards. A network of communication devices, servers, and the like also may be established to relay payment related information among the different parties of a payment transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at various merchants who agreed to accept the payment card.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

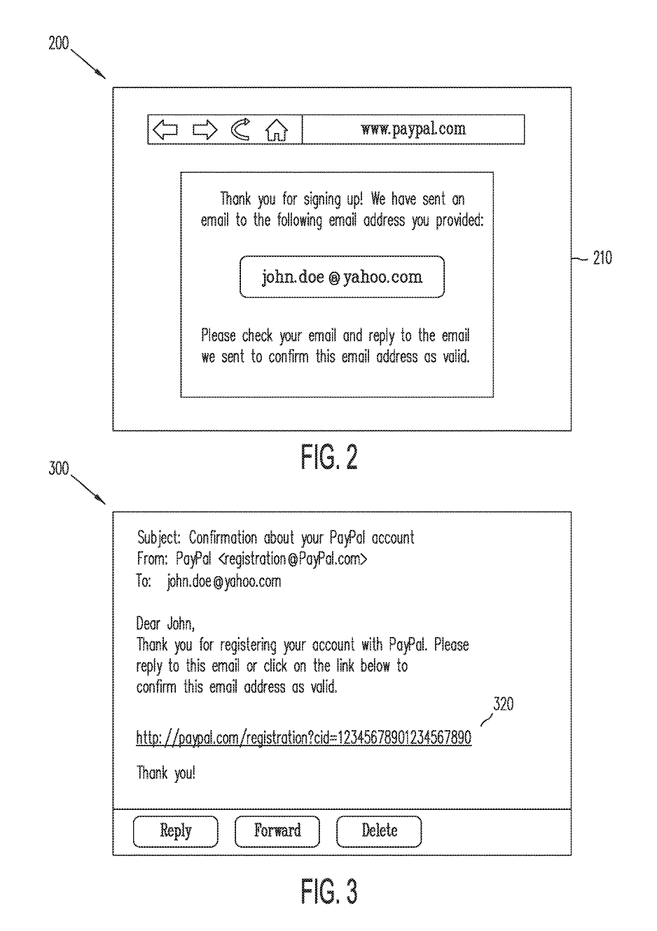

FIG. 2 illustrates an example web page 200 displayed on an electronic device. The electronic device may include a smartphone or a tablet computer, for example an Apple® iPhone®, an Android® phone, or a Windows® phone, an Apple® iPad®, an Android® tablet, or a Windows® Surface® tablet, a laptop computer, or a desktop computer. The web page 200 is a web page of a service provider. The service provider may be a third party payment provider, for example PAYPAL®, Inc. of San Jose, Calif. Alternatively, the service provider may be another entity offering services online, for example it may be a web site hosting service provider, Internet service provider, a search engine, an Internet portal, an email provider, a device manufacturer, an operating system maker, a web content provider, a game programmer, etc. In some embodiments, the service provider may be a merchant with or without a physical store.

The web page 200 in FIG. 2 helps illustrate a part of an account registration process in which a user registers (or sets up) an account with the service provider. During the account set up, the user has provided an email address that the user identifies as his own (and from which the user can be reached). The email address in this example is john.doe@yahoo.com. At some point during (or after) the account registration, the service provider sends an email to the email address supplied by the user and asks the user to confirm the email. For example, as shown in FIG. 2, the service provider informs the user via a message 210, “Thank you for signing up! We have sent an email to the following email address you provided: john.doe@yahoo.com. Please check your email and reply to the email we sent to confirm this email address as valid.” Some of the reasons for sending such emails include: verifying that the user is indeed a real person (and not a “bot”), that the supplied email address is correct or valid, or that the user is indeed who he says he is (e.g., making sure the user did not supply a legitimate email address that belongs to someone else).

Unfortunately, the response rate from users for these emails may be low. In other words, many users—real human beings who indeed own the email address—did receive these emails but did not reply to them as instructed. One reason for not replying may be that the email was sent (and received) while the user was still going through the account registration process, and the user may not pay immediate attention to the email. By the time the registration is completed, the user will have forgotten about that email. Another reason may be that the user is simply too lazy to reply to emails that he deems as “not important.” A further reason may be that the user may be reluctant to reply to emails when there is a perceived risk of divulging personal sensitive information. These problems discussed above are problems that specifically arise out of the realm of computer networks (e.g., involving an Internet-based transactions context). The present disclosure includes a solution that is necessarily rooted in Internet computer technology to overcome these problems, as discussed below.

Referring now to FIG. 3, an example email message 300 sent from the service provider (and received by the user) is illustrated. This email message 300 may be the email message that is sent as a part of the user registration. A body of the email message 300 may read, “Dear John, thank you for registering your account with PayPal. Please reply to this email or click on the link below to confirm this email address as valid.” A link 320 is included below the body of the message, which may read, “http://paypal.com/registration?cid=12345678901234567890”. In the embodiment shown herein, “http://paypal.com/registration?cid=12345678901234567890” is a Uniform Resource Locator (URL) link. The numbers (12345678901234567890) following “cid” in the link 320 is a unique identification (ID) that is appended to (or embedded within) a more generic URL link. The unique ID is specifically generated for the user. In more detail, in response to the user registering an account with the service provider, the service provider (via one or more electronic hardware processors) generates an alphanumeric string that is unique to the user. This unique alphanumeric string is saved to an electronic database that also contains a plurality of other unique alphanumeric strings that have been generated for other users. In this manner, each of the alphanumeric strings serves as a unique ID for a respective one of the users.

The following Javascript code illustrates an example manner in which the unique ID may be generated:

int x = 4;
char[ ] PIN = new char[x];
int c = ‘A’;
for(int p = 0; p < 4; p++)
{
int PIN = 0 + (int) (Math.random( )* 10);
switch(PIN)
{
case 0: c = ‘0’ + (int)(Math.random( ) * 10); break;
case 1: c = ‘A’ + (int)(Math.random( ) * 26); break; }
PIN[p] = (char)c; }
return new String(PIN);

The above Javascript code may be used to generate an alpha-numeric unique ID by using randomly selected characters between 0-9 and a-z. It is understood that the above example of the unique ID's generation is not intended to be limiting, and that other suitable unique ID generation techniques may be utilized in other embodiments.

The user receiving the email message 300 may click on the link 320, which will take the user to an appropriate web page hosted or controlled by the service provider. In doing so, the user sends an electronic request to access the web page, where the electronic request contains the unique ID. The service provider detects the electronic request to access the web page and retrieves the unique ID from the electronic request. Thereafter, the service provider matches the retrieved unique ID to a corresponding unique ID in the electronic database. Once a match is found, the service provider will be able to determine which user the unique ID belongs to. The service provider may then confirm the email address as being a valid email address.

As discussed above, sometimes the user will not respond to the email 300. As such, the link 320 containing the unique ID will not be clicked. According to the present disclosure, if the user has not accessed the link 320 in the email message 300 after a predetermined period of time (e.g., a few hours, a few days, a few weeks, or a few months), then the service provider may embed the unique ID in a link similar to the link 320 in one or more subsequent email messages sent to the user.

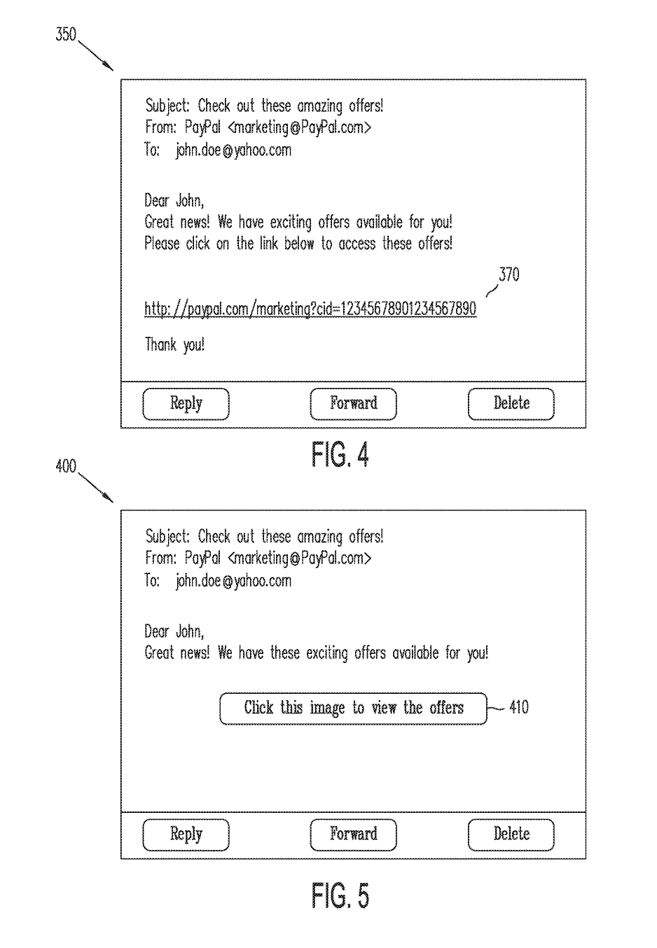

An example of such an email message is shown in FIG. 4 as email message 350. The email message 350 is a message informing the user that he has offers awaiting him. A body of the message 350 may read, “Dear John, Great news! We have exciting offers available for you! Please click on the link below to access these offers!” A link 370 is included below the body of the message, which may read, “http://paypal.com/marketing?cid=12345678901234567890”. Again, the string “12345678901234567890” following “cid” in the link 370 is a unique ID that had been specifically generated for the user. Suppose that the user clicks on the link 370 to view the offers awaiting him, the service provider may detect and retrieve the unique ID 370 from the request to access the offers (the request being initiated by the clicking of the link 370). It is understood that the unique ID may be embedded in other types of messages sent to the user after the initial email message 300. The more messages that are sent to the user, the higher the likelihood that the user will eventually click on the link (with the unique ID appended thereto), which will then allow the service provider to retrieve the unique ID subsequently and confirm the user's email address accordingly.

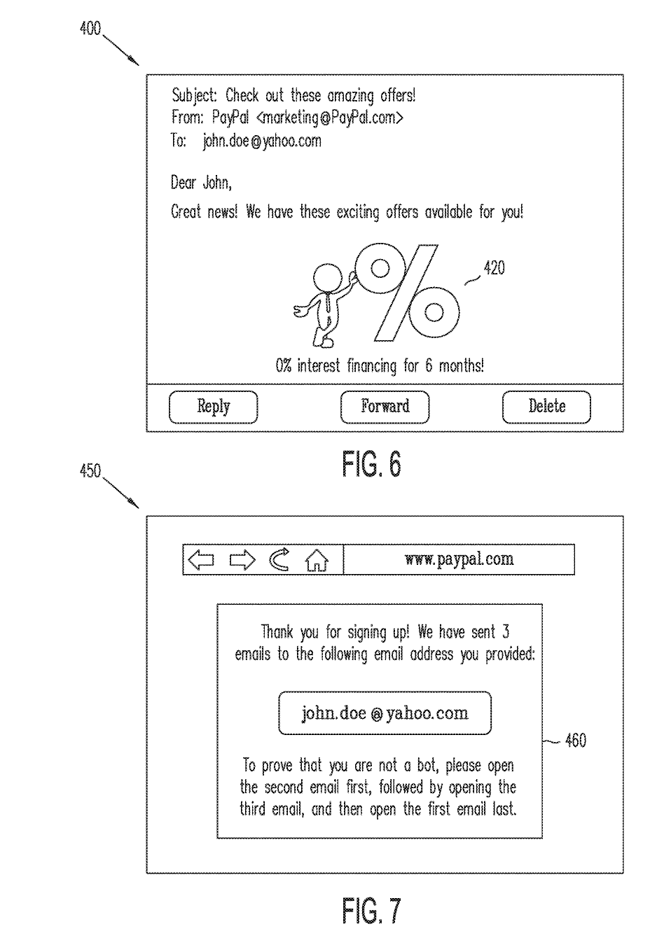

FIGS. 5-6 illustrate another example email message 400 according to embodiments of the present disclosure. The email message 400 may contain any type of message, for example it may containing a marketing message that reads, “Dear John, Great news! We have these exciting offers available for you!” However, unlike the email messages 300 or 350, the email message 400 may or may not include a conventional URL link. Instead, the email message 400 contains a button 410 (or another suitable interactive web component) that can be interactively engaged by the user. The button 410 also contains the unique ID discussed above, though the unique ID may or may not be visually identifiable by the user in the email message 400. For example, the unique ID may be too small to be comfortably read by the human eye, or it may be obfuscated, or visually hidden altogether. Upon a detected user engagement of the button 410, an electronic request to access a web resource is sent to the service provider, and the service provider may then retrieve the unique ID based on the electronic request. The service provider may then match the retrieved ID with an existing ID in the electronic database discussed above in order to identify the user.

As an example illustration, the button 410 shown in FIG. 5 may read, “Click this image to view the offers.” Until the user clicks on the button 410, the button 410 is merely a button and does not display any images. Referring now to FIG. 6, in response to the user clicking on the button 410, an image 420 is loaded, for example an image showing the text “0% interest financing for 6 months!” with the corresponding graphics. The loading of the image 420 may involve the electronic device (on which the email message 400 is viewed) sending an electronic request to a server of the service provider. The electronic request specifies the appropriate image to download to the electronic device, and the electronic request also includes the unique ID (e.g., 12345678901234567890) that had been generated for the user. The service provider retrieves the unique ID and can then confirm the user's email address based on a match with a corresponding ID in its electronic database. In the process discussed above, the user may not even be aware that he had confirmed his email address, since in his mind, he did not appear to explicitly send an email confirmation back to the service provider.

Based on the discussions above, the solution offered involving the email messages 300, 350, and 400 is necessarily rooted in computer or Internet technology to overcome the problem of low user response rate to confirm their identities through email communications or more generally electronic or online security and authentication. For example, by sending the user one or more emails (e.g., the email message 350) after the “initial” email message 300, the user is less likely to forget to reply. Compared to conventional schemes where the user can confirm his email address only by replying to the original email message, the present disclosure allows the user to effectively confirm his email address via an interaction (e.g., clicking on the link 370 with the unique ID embedded therein) with any one of a number of subsequent email messages. As long as the user interacts with one of these subsequent email messages (e.g., by clicking on the link 370), the user's email address can be confirmed by retrieving and matching the unique ID with a corresponding ID in the electronic database of the service provider.

In addition, the present disclosure should alleviate user privacy concerns. Some users may feel that “replying to an email to officially confirm his email address” may entail a significant privacy concern, and as such they may be unwilling to do so. In comparison, these users may feel that “clicking on a link to view offers from a service provider” is less of a privacy concern, because not only is this a less formal interaction, but the user may also not even be aware that he is actually confirming his email address just by clicking on a link to view an offer. Furthermore, according to the embodiment shown in FIGS. 5-6 involving the loading of an image in an email message, the user may not even realize that he is effectively sending a confirmation message back to the service provider. In other words, users who are concerned about privacy may be much more willing to load an image in an email message under the pretenses of viewing offers (or for whatever other reasons), than to reply to an email or to click on a link for the sole purpose of sending a confirmation back to the service provider.

For users who were too lazy to reply to the initial email, they may still end up interacting with at least one of the subsequent email messages 350, particularly if they were interested in the message underlying the link. Alternatively, these users may not be too lazy to load an image (e.g., the image 420) in an email, even if they may be too lazy to reply to an email or to click on a link to open up a web page.

For these reasons discussed above, the embodiments of the present disclosure may yield a significantly higher response rate (compared to conventional schemes) due to the user either knowingly or unknowingly confirming his/her email address. However, although the email address has been confirmed as a legitimate email address, there are still risks that the user may be a bot or an imposter. To minimize these risks, the present disclosure allows the service provider to establish and analyze a risk profile for each user, in order to determine whether or not the user should be granted access to the account with the service provider.

Part of the risk profile establishment and analysis is to determine whether the user is a computer “bot” or a legitimate human user. This may involve a Turing test, which is a test designed to tell humans and machines apart. One way to perform the Turing test is to see if the user can follow language-based instructions. Even though computer technology has progressed significantly in recent years, most computer “bots” are still not sophisticated enough to understand and follow simple instructions that a human user can comprehend with ease. According to an embodiment of the present disclosure, the service provider may send a series of email messages to the email address provided by the user and ask the user to open these emails according to a predefined sequence.

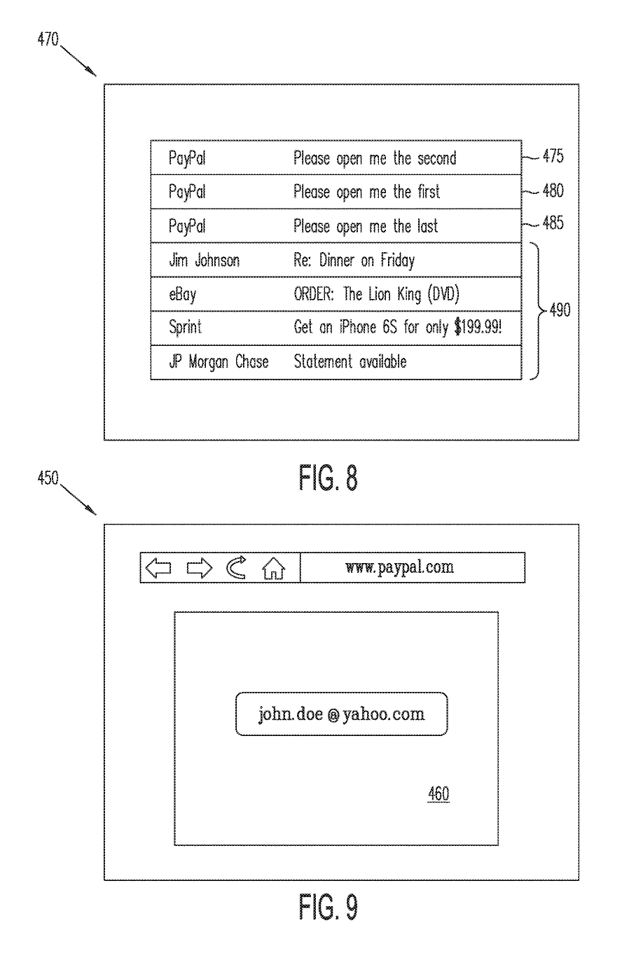

An example of this Turing test is shown in FIGS. 7-8. Referring to FIG. 7, a web page of the service provider displays the following example instructions 460, “Thank you for signing up! We have sent 3 emails to the following email address you provided: john.doe@yahoo.com. To prove that you are not a bot, please open the second email first, followed by opening the third email, and then open the first email last.” These instructions 460 inform the user the reason why he needs to perform the tasks, and how to do so.

Referring now to FIG. 8, the user opens an email inbox 470 and sees recently received email messages 475, 480, and 485 (along with a plurality of previously received messages 490). Optionally, the subject line of the email messages 475, 480, and 485 may also include instructions on the sequence that they should be opened. For example, the last email 475 has a subject line “Please open me the second”, the second email 480 has a subject line “Please open me the first”, and the first email 485 has a subject line “Please open me the last.” Based on the instructions 460 displayed on the web page 450, or based on the instructions as a part of the subject lines in the inbox 470, a human user should have no trouble opening the email message 480 first, followed by the email message 475, and then the email message 485 last. However, a bot may encounter substantial difficulty in understanding and following these instructions and therefore may make mistakes in terms of the sequence.

Based on the detected results of the sequence in which the emails 475, 480, and 485 were opened, the service provider may determine whether the user is likely a bot. For example, if the sequence in which the emails 475-485 were opened is completely correct, then the service provider may assign a low risk score to the user—meaning that the user is unlikely to be a bot. If the sequence has a minor mistake, then the service provider may assign an intermediate risk score to the user—meaning that there is a non-negligible risk that the user is a bot. If the sequence has many mistakes, then the service provider may assign a high risk score to the user—meaning that there is a significant risk that the user is a bot. This may be even more apparent when the sequence is more complicated. For example, when more than 3 emails are sent to the user, it allows a sequence to have significantly more permutations, which means following the specified sequence correctly is more indicative of a real human user. In some embodiments, the user may be instructed to open only a subset of the emails received. For example, 10 emails may be sent to the user, and the user may be instructed to only open the last 5 emails according to a specified sequence. Thus, if the user has opened any of the first 5 emails, it may be a sign that the user has failed the Turing test.

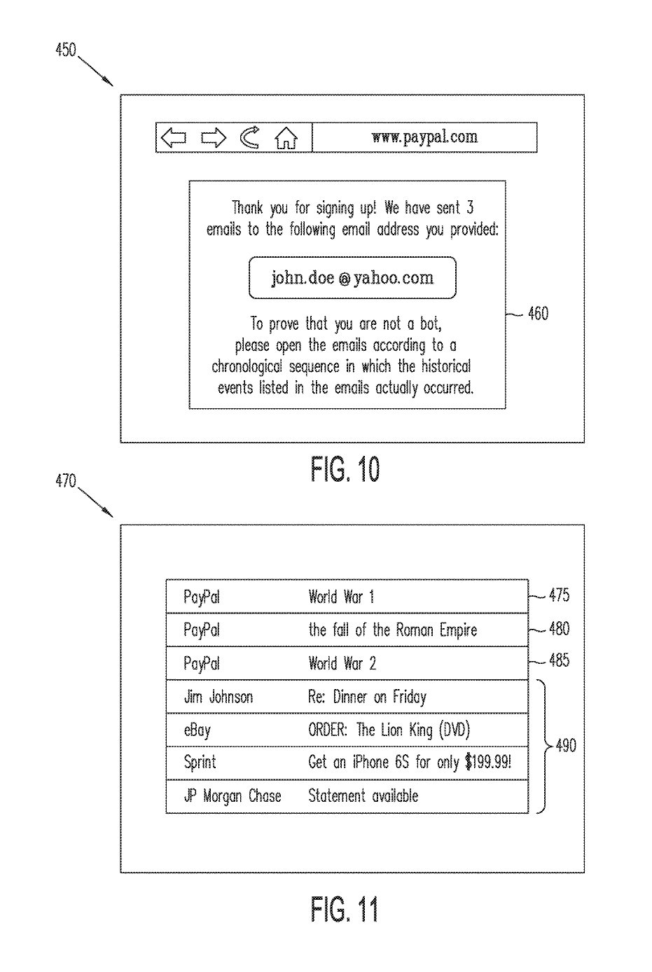

It is understood that the instructions themselves may be made to be more challenging (to a machine but not to a human) than what is shown in FIGS. 7-8. For example, as shown in FIG. 9, the instructions 460 on the web page 450 may be visually obfuscated to make them harder for a bot to read and understand. In other embodiments, the instructions may involve puzzles that a human user can easily solve, but a bot may have difficulties. For example, the emails may each represent a historical event (e.g., indicated in their respective subject lines). And as shown in FIG. 10, the instructions 460 on the web page 450 may prompt the user to open the emails according to a chronological sequence in which these historical events occurred. For example, as shown in FIG. 11, the email message 475 may have a subject line of “World War 1”, the email message 480 may have a subject line of “the fall of the Roman Empire”, and the email message 485 may have a subject line of “World War 2”. A human user should have no problem solving this puzzle and will be able to open the emails according to the sequence of email 480 first, the email 475 next, and the email 485 last.

Of course, the Turing test is not limited to the sequence of opening emails. Any test that can be easily performed by a human but not a machine can be used. In that regard, any suitable CAPTCHA (Completely Automated Public Turing Test to tell Computers and Humans Apart) may be used. For example, in a single email message such as the email message 400, the loadable image may include an interactive CAPTCHA. Different types of CAPTCHAs are discussed in more detail in U.S. patent application Ser. No. 13/174,394, filed on Jun. 30, 2011, entitled “Interactive CAPTCHA”, the disclosure of which is hereby incorporated by reference in its entirety. Based on the detected user response to the CAPTCHA, different risk scores may be assigned to the user.

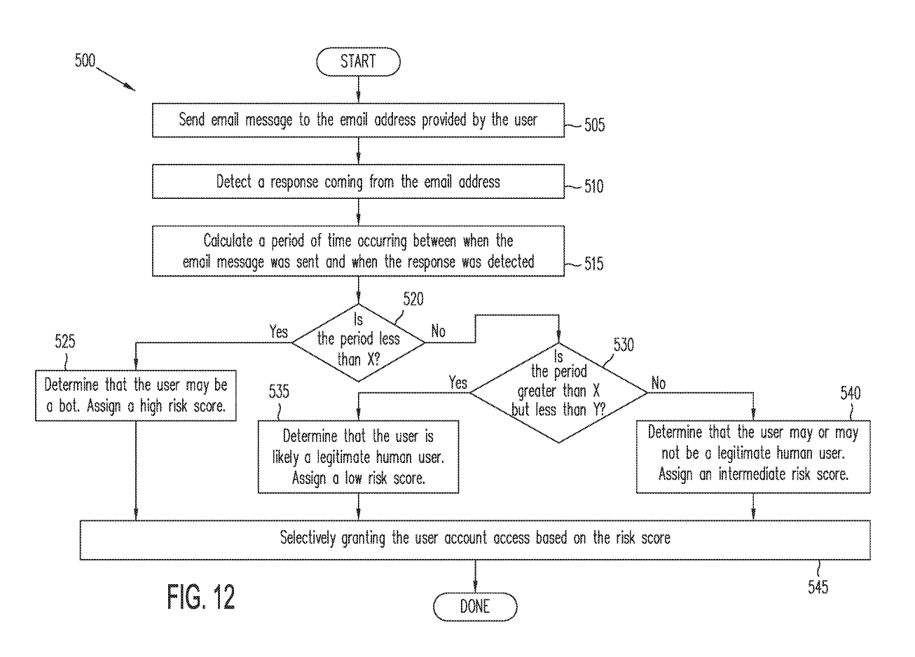

In some other embodiments, a timing of the user's replies or responses to the emails 300, 350, and 400 discussed above may be evaluated as a part of the risk profile establishment and analysis. For example, referring now to FIG. 12, a method 500 of establishing and analyzing a user risk profile begins with a step 505, in which an email message is sent to the email address provided by the user. This email message may be any one of the email messages 300, 350, 400, or 475-485 discussed above. The method 500 continues with a step 510, in which a response coming from the email address is detected. For example, this may involve the service provider receiving a reply email from the user, a request to access the link 320 or 370, or a request to load the image 420.

The method 500 continues with 515, in which the service provider calculates a period of time occurring between when the email message was sent (to the email address provided by the user) and when the response was detected from the user. For example, the email message may have been sent at 9:00:00 AM on Apr. 5, 2016, and the response may have been detected at 9:01:05 AM on Apr. 5, 2016. In that case, the period of time is 1 minute and 5 seconds. Of course, in real world situations, this period of time may be anywhere from a few seconds, a few minutes, a few hours, a few days, a few weeks, or a few months or even years.

According to the various aspects of the present disclosure, the timing of the detected response is important. For example, a very short response time (e.g., less than a few seconds) may be indicative of a bot, rather than a human, initiating the response. This is because a bot can react much more quickly than a human. On the other hand, if the response took too long, there is a concern that the response did not come from the real legitimate human user, but that it may have come from an imposter. Thus, a “sweet spot” of response time (that is indicative of the real legitimate human user) may lie somewhere in between, in other words, a response time that is not too quick but not too long either.

For these reasons, the method 500 includes a decision step 520 to determine whether the calculated period is less than X, where X is a predefined amount of time (e.g., X may be a few seconds). If the answer from the decision step 520 is yes, then at step 525 the service provider determines that the user may be a bot, and a high risk score is assigned to the user. If the answer from the decision step 520 is no, then at a decision step 530 a decision is made to whether the period is greater than X but less than Y (where Y may be a few minutes, a few hours, or a few days, depending on the context and the situation). If the answer from the decision step 530 is yes, then that means that the response time falls within the aforementioned “sweet spot”, and at step 535 the user is determined to likely be a legitimate human user who is not an imposter. A low risk score may be assigned to the user accordingly. If the answer from the decision step 530 is no, that means the response time no longer falls within the “sweet spot” because it took too long. Thus, at step 540 the user is determined to be likely a real human, but he may or may not be the legitimate user. In other words, there is a chance that the user may still be an imposter. But due to the uncertainty, only an intermediate (rather than high) risk score is assigned to the user.

At step 545, the service provider selectively grants the user access to the account based on the risk score. For example, the service provider may deny the user access to the account in response to a high risk score, grant the user access to the account in response to a low risk score, or require further security information (e.g., a login) from the user in response to an intermediate risk score.

In another embodiment of establishing and analyzing risk profiles for users, the service provider may extract an IP address from the electronic request received from the user (e.g., by clicking on the links or loading the image). The service provider may determine a geographical area that is associated with the IP address and see if it is consistent with the mailing or shipping address supplied by the user during account registration. For example, the user may have provided a mailing or shipping address in San Jose, Calif., USA during the account registration. However, the IP address is associated with India (or another country outside the United States). This is considered an inconsistency, and it may be an indication of potential fraud. As such, the risk score may be increased.

However, the user's mailing or shipping address and the geographical region associated with the IP address need not necessarily be identical for them to be considered consistent. For example, the geographical region associated with the IP address may be within the same zip code, the same town, the same city, or even the same state, as the user's registered address, and they could still be considered to be consistent. The reason may be that the user could be at work (whereas the mailing address is a home address) or out in public, or he may be traveling out of town for work or leisure. In some embodiments, a granular approach may be used, where a risk score is increased as a function of the degree of mismatch between the physical address and the geographical area associated with the IP address (e.g., the bigger the mismatch, the greater the risk score).

In yet another embodiment of establishing and analyzing risk profiles for users, technologies such as the “One Touch™” feature of PayPal may be used to further evaluate the user risk profile. For example, using computer “cookies”, One Touch™ allows a user to stay signed in to PayPal on a given user device, which means the user need not sign in to PayPal every time the user wishes to make a payment using PayPal. If the service provider detects that the user response (to the email address verification) is received while One Touch™ was enabled, that is an indication that the user is likely the real user and not an imposter, and correspondingly the risk score may be lowered.

In yet other embodiments, the risk profile establishment and analysis may involve requiring the user to perform a login with the correct username and password. If the correct combination of the username and password could not be produced, a high risk score may be assigned to the user.

The above examples for establishing and analyzing risk profiles for users are not intended to be limiting. It is also understood that these examples may be combined with one another to improve the accuracy of the risk profiles. In all these examples, it can be seen that the solution is necessarily rooted in computer technology to solve a problem that specifically arose in the realm of computer networks.

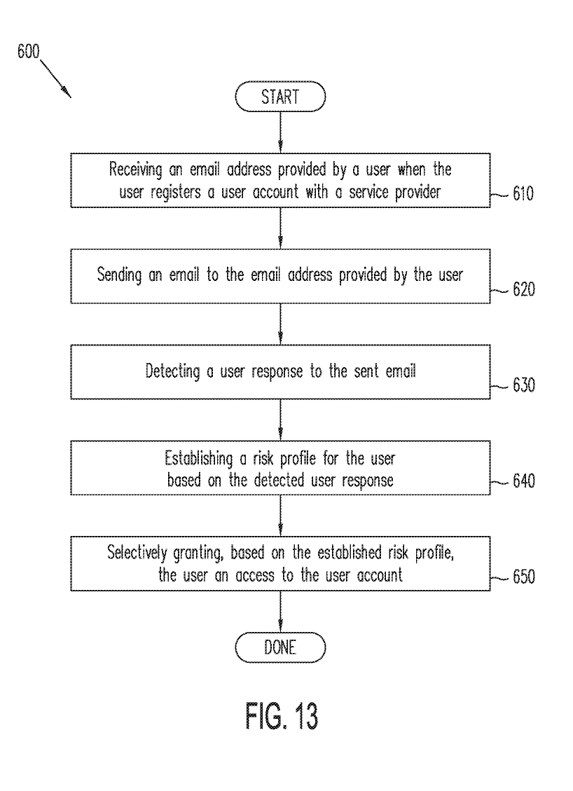

FIG. 13 is a flowchart illustrating a method 600 of enhancing electronic information security by conducting risk profile analysis to confirm user identity according to the various aspects of the present disclosure discussed above. It is understood that one or more of the steps 610-650 may be performed by one or more electronic processors of a service provider.

The method 600 includes a step 610 of receiving an email address provided by a user when the user registers a user account with a service provider.

The method 600 includes a step 620 of sending an email to the email address provided by the user.

The method 600 includes a step 630 of detecting a user response to the sent email.

The method 600 includes a step 640 of establishing a risk profile for the user based on the detected user response.

The method 600 includes a step 650 of selectively granting, based on the established risk profile, the user an access to the user account.

It is also understood that additional method steps may be performed before, during, or after the steps 610-650 discussed above. For example, in some embodiments, the method 600 further includes a step of generating a unique ID for the user. In that case, the step 620 of sending the email comprises embedding the unique ID in the email, and the step 630 of detecting the user response comprises receiving the unique ID from the user. The method 600 may further include a step of confirming the email address as a valid email address in response to the received unique ID being identical as the generated unique ID. In some embodiments, the unique ID is embedded as a part of an active (e.g., clickable) Uniform Resource Locator (URL) link in the email, the detecting step 630 comprises detecting a user access of the URL link, and the receiving the unique ID comprises retrieving the unique ID in response to the detected user access of the URL link. In some other embodiments, the unique ID is associated with a loadable image in the sent email, and the detecting step 630 comprises detecting a request to load the image in the email, and the receiving the unique ID comprises retrieving the unique ID in response to the request to load the image.

In some embodiments, the step 620 of sending the email comprises applying a Turing test via the email. In some embodiments, the applying the Turing test comprises sending a plurality of emails to the email address within a predetermined time span, and prompting the user to open one or more of the plurality of emails according to a specified sequence. In these embodiments, the detecting step 630 comprises detecting a sequence in which the one or more emails are opened, and the establishing step 640 comprises determining whether the user passed the Turing test based on whether the detected sequence is the same as the specified sequence. In some embodiments, the prompting comprises displaying obfuscated instructions or displaying instructions that contain a puzzle.

In some embodiments, the detecting step 630 comprises detecting a user interaction with the sent email. The method 600 also includes a step of calculating a period of time occurring between the sending of the email and the detecting of the user interaction. The establishing step 640 comprises: assigning a risk score for the user as a function of the calculated period of time. In some embodiments, the assigning the risk score comprises: assigning a first risk score in response to the calculated period of time being within a predefined time range, and assigning a second risk score in response to the calculated period of time being outside the predefined time range, the second risk score being greater than the first risk score.

In some embodiments, the detecting step 630 comprises retrieving an IP address associated with the user response to the sent email, and the establishing step 650 comprises determining whether a geographical region associated with the IP address is consistent with a physical address provided by the user when the user account is registered.

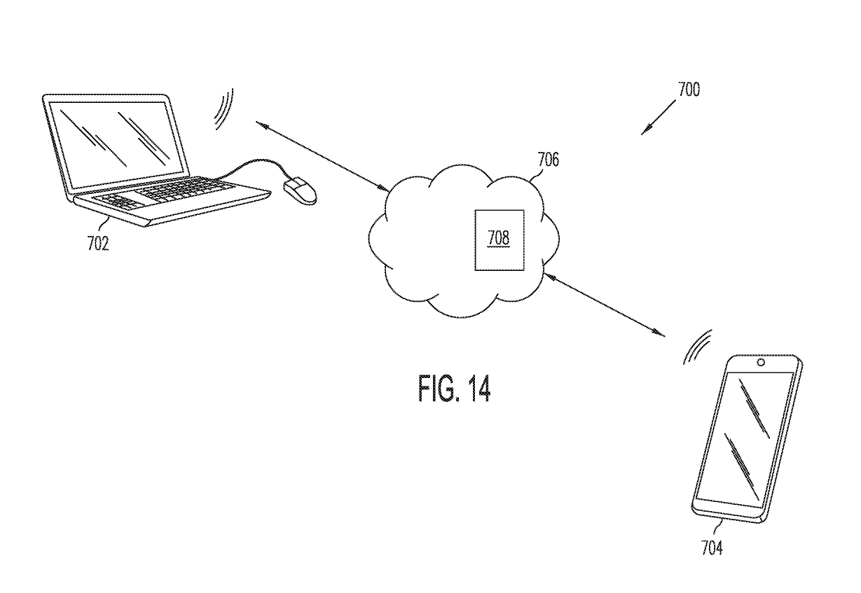

FIG. 14 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704. The computer 702 and the mobile device 704 may each be configured to perform the steps of the method 500 and 600 discussed above, or they may be configured as a user device to register accounts with a service provider, receive emails from the service provider, and interact with the emails sent from the service provider in a manner consistent with the discussions above.

The computer 702 and the mobile device 704 may each be in communication with cloud-based resources 708, which may include one or more computers, such as server computers, with adequate memory resources to handle requests from a variety of users. The server computers may include servers from the third party payment provider. The plugin (or extension) on the computer 702 or on the mobile device 704 may report, to the cloud-based resources 708 (e.g., to the servers from the third party payment provider) which online merchants still do not natively support the third party payment provider's services. A list of such merchants may be saved electronically using the cloud-based resources 708. In some embodiments, the functionality between the mobile device 704 and the cloud-based resources 708 may be divided up in any appropriate manner. For example, an app on mobile device 704 may perform basic input/output interactions with the user, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702.

It is understood that the various components of cloud-based computing architecture 700 are shown as examples only. For instance, a given user may access the cloud-based resources 708 by a number of devices, not all of the devices being mobile devices. Similarly, a merchant or another user may access resources 708 from any number of suitable mobile or non-mobile devices. Furthermore, the cloud-based resources 708 may accommodate many merchants and users in various embodiments.

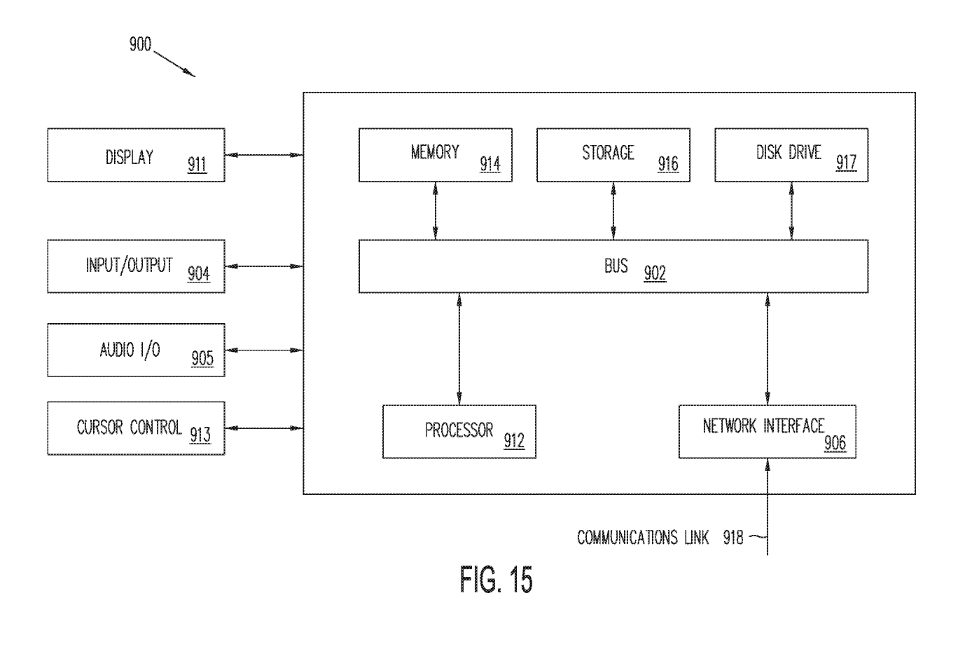

FIG. 15 is a block diagram of a computer system 900 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons or links, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. A transceiver or network interface 906 transmits and receives signals between computer system 900 and other devices, such as another user device, a merchant server, or a payment provider server via network 360. In one embodiment, the transmission is wireless, although other transmission mediums and methods may also be suitable. A processor 912, which can be a micro-controller, digital signal processor (DSP), or other processing component, processes these various signals, such as for display on computer system 900 or transmission to other devices via a communication link 918. Processor 912 may also control transmission of information, such as cookies or IP addresses, to other devices.

Components of computer system 900 also include a system memory component 914 (e.g., RAM), a static storage component 916 (e.g., ROM), and/or a disk drive 917. Computer system 900 performs specific operations by processor 912 and other components by executing one or more sequences of instructions contained in system memory component 914. Logic may be encoded in a computer readable medium, which may refer to any medium that participates in providing instructions to processor 912 for execution. Such a medium may take many forms, including but not limited to, non-volatile media, volatile media, and transmission media. In various implementations, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present disclosure offers various advantages over conventional schemes of verifying user identity. It is understood, however, that not all advantages are necessarily disclosed herein, different embodiments may offer different advantages, and that no particular advantage is required for all embodiments.

One advantage is that by generating and embedding a unique ID in an email sent to the user's provided email address, a subsequent user interaction with that email may allow the service provider to confirm the user's email address as being valid. Since the user may not even be aware of his act of “confirming the email address”, this allows a greater response rate from users who were reluctant to confirm the email address due to privacy concerns. Also, since the unique ID may be embedded in a plurality of emails sent to the user, this maximizes the likelihood that the user will respond to (or interact with) at least one of these emails, which will confirm the validity of the email address in the process. Furthermore, the embedding of the unique ID in a loadable image further increases the likelihood that the user will (unknowingly) sent the unique ID back to the service provider (e.g., by loading the image).

Yet another advantage is that the user risk profile establishment and analysis performed by the present disclosure can catch computer bots. For example, by performing a Turing test (e.g., asking the user to open a plurality of emails according to a specified sequence, or understand and solve puzzles), the present disclosure can determine the likelihood that the user is a computer bot. If a user is indeed determined to be a computer bot, then access to the user account may be denied until further proof that the user is not a bot. The bot determination may also be done by evaluating how quickly the user responded to the email asking for the confirmation of the email address.

A further advantage is that the user risk profile establishment and analysis performed by the present disclosure reduces the likelihood of fraud. For example, by retrieving an IP address from the user and comparing a geographical region associated with the retrieved IP address with a physical address registered to the user's account, the service provider may catch imposters (who may be either human or bots) who are pretending to be the user. Again, access to the user account may be denied until further proof that the user requesting access is actually the real legitimate human user himself. These procedures thwart and discourage fraudsters and therefore enhance the electronic information security of the system discussed herein.

One aspect of the present disclosure involves a method of enhancing electronic information security by conducting risk profile analysis to confirm user identity. The method includes: receiving an email address provided by a user when the user registers a user account with a service provider; sending an email to the email address provided by the user; detecting a user response to the sent email; establishing a risk profile for the user based on the detected user response; and selectively granting, based on the established risk profile, the user an access to the user account. At least one of the receiving, the sending, the detecting, the establishing, and the selectively granting is performed at least in part by one or more electronic hardware processors of the service provider.

Yet another aspect of the present disclosure involves a non-transitory machine-readable medium having stored thereon machine-readable instructions executable to cause a machine to perform operations comprising: receiving an email address provided by a user when the user registers a user account with a service provider; generating a unique ID for the user; sending an email to the email address provided by the user, the email containing the unique ID; detecting a user response to the sent email, the user response containing the unique ID; confirming the email address as a valid email address in response to the detecting; conducting a risk profile analysis for the user based on the detected user response; and selectively granting, based on the conducted risk profile analysis, the user an access to the user account.

A further aspect of the present disclosure involves an electronic system. The system includes a non-transitory memory storing instructions. The system includes one or more hardware processors coupled to the non-transitory memory. The one or more hardware processors are configured to read the instructions from the non-transitory memory to cause the system to perform operations comprising: receiving an email address provided by a user when the user registers a user account with a service provider; generating a unique ID for the user; sending an email to the email address provided by the user, the unique ID being embedded in the email as a part of an active Uniform Resource Locator (URL) link or in a loadable image; detecting a user response to the email, the user response including a request to access the URL link or to load the image; retrieving the unique ID from the request; confirming the email address as a valid email address in response to the retrieved unique ID being identical to the generated unique ID; conducting a Turing test to determine whether the user is a computer bot; and granting the user access to the user account in response to the email address being confirmed as the valid email address and a determination that the user is not a computer bot.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
receiving an email address provided by a user when the user registers a user account with a service provider;
sending an email to the email address provided by the user;
detecting a user response to the sent email;
establishing a risk profile for the user based on the detected user response; and
selectively granting, based on the established risk profile, the user an access to the user account;
wherein at least one of the receiving, the sending, the detecting, the establishing, and the selectively granting is performed at least in part by one or more electronic hardware processors of the service provider.

2. The method of claim 1, further comprising: generating a unique ID for the user, wherein the sending the email comprises embedding the unique ID in the email, and wherein the detecting the user response comprises receiving the unique ID from the user.

3. The method of claim 2, further comprising: confirming the email address as a valid email address in response to the received unique ID being identical as the generated unique ID.

4. The method of claim 2, wherein:
the unique ID is embedded as a part of an active Uniform Resource Locator (URL) link in the email;
the detecting comprises detecting a user access of the URL link; and
the receiving the unique ID comprises retrieving the unique ID in response to the detected user access of the URL link.

5. The method of claim 2, wherein:
the unique ID is associated with a loadable image in the sent email;
the detecting comprises detecting a request to load the image in the email; and
the receiving the unique ID comprises retrieving the unique ID in response to the request to load the image.

6. The method of claim 1, wherein the sending of the email comprises applying a Turing test via the email.

7. The method of claim 6, wherein the applying the Turing test comprises:
sending a plurality of emails to the email address within a predetermined time span; and
prompting the user to open one or more of the plurality of emails according to a specified sequence.

8. The method of claim 7, wherein:
the detecting comprises detecting a sequence in which the one or more emails are opened; and
the establishing comprises determining whether the user passed the Turing test based on whether the detected sequence is the same as the specified sequence.

9. The method of claim 7, wherein the prompting comprises displaying obfuscated instructions or displaying instructions that contain a puzzle.

10. The method of claim 1, wherein the detecting comprises detecting a user interaction with the sent email.

11. The method of claim 10, further comprising: calculating a period of time occurring between the sending of the email and the detecting of the user interaction, and wherein the establishing comprises: assigning a risk score for the user as a function of the calculated period of time.

12. The method of claim 11, wherein the assigning the risk score comprises:
assigning a first risk score in response to the calculated period of time being within a predefined time range; and
assigning a second risk score in response to the calculated period of time being outside the predefined time range, the second risk score being greater than the first risk score.

13. The method of claim 1, wherein:
the detecting comprises retrieving an IP address associated with the user response to the sent email; and
the establishing the risk profile comprises determining whether a geographical region associated with the IP address is consistent with a physical address provided by the user when the user account is registered.

14. A non-transitory machine-readable medium having stored thereon machine-readable instructions executable to cause a machine to perform operations comprising:
receiving an email address provided by a user when the user registers a user account with a service provider;
generating a unique ID for the user;
sending an email to the email address provided by the user, the email containing the unique ID;
detecting a user response to the sent email, the user response containing the unique ID;
confirming the email address as a valid email address in response to the detecting;
conducting a risk profile analysis for the user based on the detected user response; and
selectively granting, based on the conducted risk profile analysis, the user an access to the user account.

15. The non-transitory machine-readable medium of claim 14, wherein:
the unique ID is embedded as a part of an active Uniform Resource Locator (URL) link in the email or embedded in a loadable image; and
the detecting comprises:
detecting a user access of the URL link or detecting a request to load the image; and
retrieving the unique ID in response to the detected user access of the URL link or in response to the detected request to load the image.

16. The non-transitory machine-readable medium of claim 14, wherein the sending of the email is performed such that the email comprises a Turing test.

17. The non-transitory machine-readable medium of claim 14, wherein the conducting the risk profile analysis comprises determining whether the user is a human user or a computer bot based on how quickly the user response is detected after the sending of the email.

18. The non-transitory machine-readable medium of claim 14, wherein:
the detecting comprises retrieving an IP address associated with the user response to the sent email; and
the conducting the risk profile analysis comprises assigning a risk score to the user as a function of a degree of mismatch between a geographical area associated with the IP address and a physical address provided by the user when the user account is registered.

19. A system, comprising:
a non-transitory memory; and
one or more hardware processors coupled to the non-transitory memory and configured to read instructions from the non-transitory memory to cause the system to perform operations comprising:
receiving an email address provided by a user when the user registers a user account with a service provider;
generating a unique ID for the user;
sending an email to the email address provided by the user, the unique ID being embedded in the email as a part of an active Uniform Resource Locator (URL) link or in a loadable image;
detecting a user response to the email, the user response including a request to access the URL link or to load the image;
retrieving the unique ID from the request;
confirming the email address as a valid email address in response to the retrieved unique ID being identical to the generated unique ID;
conducting a Turing test to determine whether the user is a computer bot; and
granting the user access to the user account in response to the email address being confirmed as the valid email address and a determination that the user is not a computer bot.

20. The system of claim 19, wherein the Turing test is conducted at least in part via the sending of the email and the detecting of the user response.
